(19) United States
(12) Patent Application Publication
(10) Pub. No.: US 2023/0095725 A1
(43) Pub. Date: Mar. 30, 2023

(54) METHOD OF PROCESSING QUANTUM CIRCUIT, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Shusen LIU, Beijing (CN); Danxiang WU, Beijing (CN); Shenjin LV, Beijing (CN)

(73) Assignee: BEIJING BAIDU NETCOM SCIENCE TECHNOLOGY CO., LTD., Beijing (CN)

(21) Appl. No.: 18/071,567

(22) Filed: Nov. 29, 2022

(30) Foreign Application Priority Data
Dec. 1, 2021 (CN) 202111460569.2

(51) Int. Cl. G06N 10/20

(52) U.S. Cl. CPC G06N 10/20

(57) ABSTRACT

A method of processing a quantum circuit, an electronic device, and a storage medium. A specific implementation solution includes: determining a program logic graph of the quantum circuit, wherein the program logic graph indicates a plurality of logic bits and a logic relationship between the plurality of logic bits; mapping at least part of the plurality of logic bits to corresponding physical bits in a plurality of physical bits in the quantum circuit according to measurement fidelities of the plurality of physical bits and the logic relationship, so as to obtain an initial mapping relationship; and obtaining a target mapping relationship from the plurality of logic bits to the plurality of physical bits according to the initial mapping relationship and a chip coupling graph of the quantum circuit.

This application claims priority of Chinese Patent Application No. 202111460569.2, filed on Dec. 7, 2021, which is hereby incorporated herein its entirety by reference.

### TECHNICAL FIELD

Embodiments of the present disclosure relate to a field of quantum computing, in particular to a field of a quantum circuit compilation technology, and specifically to a method of processing a quantum circuit, an apparatus of processing a quantum circuit, an electronic device, a computer storage medium, and a computer program product.

### BACKGROUND

A quantum device, such as NISQ (Noise Intermediate-Scale Quantum) device, is constrained by a chip topology logic. However, a quantum gate operation acting on two qubits may be merely applied to a specific pair of adjacent bits.

### SUMMARY

In order to enable an algorithm described by a quantum circuit to run on the quantum device, it is needed to convert and optimize the quantum circuit, so that the quantum circuit has as few basic quantum gates as possible while meeting a constraint of a physical device.

The present disclosure provides a method of processing a quantum circuit, an electronic device, and a computer storage medium.

According to an aspect, a method of processing a quantum circuit is provided, including: determining a program logic graph of the quantum circuit, wherein the program logic graph indicates a plurality of logic bits and a logic relationship between the plurality of logic bits; mapping at least part of the plurality of logic bits to corresponding physical bits in a plurality of physical bits in the quantum circuit according to measurement fidelities of the plurality of physical bits and the logic relationship, so as to obtain an initial mapping relationship; and obtaining a target mapping relationship from the plurality of logic bits to the plurality of physical bits according to the initial mapping relationship and a chip coupling graph of the quantum circuit.

According to an aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the method provided by the present disclosure.

According to an aspect of the present disclosure, a non-transitory computer-readable storage medium having computer instructions therein is provided, and the computer instructions are configured to cause a computer to implement the method provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 shows a flowchart of a method of processing a quantum circuit according to embodiments of the present disclosure;

FIG. 2 shows a flowchart of a method of processing a quantum circuit according to other embodiments of the present disclosure;

FIG. 3 shows a flowchart of a method of processing a quantum circuit according to other embodiments of the present disclosure;

FIG. 4A shows a schematic diagram of a program logic graph according to embodiments of the present disclosure;

FIG. 4B shows a schematic diagram of a chip coupling graph according to embodiments of the present disclosure;

FIG. 4C shows a schematic diagram of a method of processing a quantum circuit according to embodiments of the present disclosure;

FIG. 4D shows a schematic diagram of a target mapping relationship according to embodiments of the present disclosure;

FIG. 5 shows a schematic diagram of a method of processing a quantum circuit according to other embodiments of the present disclosure;

FIG. 6 shows a block diagram of an apparatus of processing a quantum circuit according to embodiments of the present disclosure; and

FIG. 7 shows a block diagram of an electronic device to which a method of processing a quantum circuit may be applied for implementing embodiments of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skilled in the art should realize that various changes and modifications may be made to embodiments described herein without departing from the scope and spirit of the present disclosure. Likewise, for clarity and conciseness, descriptions of well-known functions and structures are omitted in the following description.

For ease of understanding, a quantum circuit without considering an algorithm of physical constraint is described as a logic circuit. A qubit in the logic circuit is called a logic bit, which is denoted as qᵢ, i∈{0, 1, 2, . . . , n−1}, where n represents a number of qubits in the logic circuit. The logic bit may be a program qubit in a quantum program. A quantum circuit obtained by conversion that meets a physical constraint is called a physical circuit. A qubit in the physical circuit is called a physical bit, which is denoted as Qᵢ, i∈{0, 1, 2, . . . , m−1}, where m represents a number of physical bits (m≥n). The physical bit may be a hardware qubit of NISQ.

An NISQ device has a severe constraint of resources, a low reliability, and a high variability in physical properties (such as qubit coherence time, operation error rate, etc.). With a goal of effectively utilizing resources and maximizing a possibility of successful operation, it is a very important task to map a logic circuit to a physical circuit operable on a quantum device.

A qubit mapping is a mapping of a logic bit to a physical bit. For example, a high-quality mapping of a logic bit to a physical bit of NISQ requires that an update frequency (i.e., a number of swap times of qubits) of the entire circuit mapping is reduced as much as possible.

Requirements for a high-quality qubit mapping may include: as few SWAP gates as possible are inserted, so as to minimize a qubit movement; an additional inserted SWAP operation (to move a qubit position) and an operation in a quantum program (single-qubit gate and CNOT gate) are arranged efficiently so that an output physical circuit is executable on a given quantum computer. The above two key steps are merely a theoretical demonstration of a feasibility of the qubit mapping, without considering the low reliability and the high variability in physical properties (qubit coherence time and operation error rate) of the NISQ device. In fact, the qubit coherent time, an error rate of CNOT gate, and an error rate of measurement may cause a failure of a program operation to a large extent. It should be noted that the longer the qubit coherence time, the better, and the lower the read error rate of the gate, the better.

According to embodiments of the present disclosure, by comprehensively considering a program logic information, a hardware topology constraint and an operation error information, and taking a high-quality mapping of qubit as a priority, mapping a logic qubit that uses more CNOTs to a physical bit with a lower measurement error rate of CNOT may improve a reliability and a success rate of a program operation, so that a resource utilization of a quantum program in an NISQ system may be improved, and an operability of a quantum program on a quantum device may be improved.

In order to better understand technical solutions of embodiments of the present disclosure, technical terms involved in the technical solutions of embodiments of the present disclosure are explained below.

CNOT gate (Control-NOT gate) is a dual-quantum operation logic gate, also known as Controlled-NOT gate. Only when a first qubit is |1 [symbol] , a NOT operation is performed on a second qubit, otherwise the second qubit may remain unchanged. The CNOT gate is generally used to entangle two quanta. In addition, the CNOT gate may also be used to control a logic state of a controlled quantum object.

SWAP gate is a dual-quantum operation logic gate. The SWAP gate allows a swap of two input qubits, and a logic composition may include three logic NOT gates; if a qubit of A is defined as 0 and a qubit of B is defined as 1, then after SWAP (A, B), a result of observation may be that the qubit of A is 1 and the qubit of B is 0.

X gate (Pauli-X Gate) is a single-quantum operation logic gate that operates one qubit, which is equivalent to a classical logic NOT gate. For example, if a qubit is |1 [symbol] before operation, the qubit may change to |0 [symbol] after entering the X gate, and vice versa, the qubit may change from |0 [symbol] to |1 [symbol] .

H gate (Hadamard Gate) is a single-quantum operation logic gate that operates on one qubit; in quantum computing, the logic gate operates on |0 [symbol] or |1 [symbol] , and then a superposition state (a state in which a quantum may be in two different attributes at the same time, e.g., 0 and 1) is obtained.

Regarding program logic graph G_{L}=(V_{L}, E_{L}), qubits in the logic circuit are points of G_{L}=(V_{L}, E_{L}), V_{L} is a set of these points, and E_{L} is a set of edges. If two qubits are connected by an edge, it means that a CNOT gate acts between the two qubits in the logic circuit.

Regarding a degree of V_{L} in the program logic graph G_{L}=(V_{L}, E_{L}), if qubits qᵢ_{₀}, qᵢ_{₁}, . . . , qᵢ_{ₛ₋₁} are connected to a point qᵢ by edges in the program graph G_{L}=(V_{L}, E_{L}), a degree of the point qᵢ is s.

Regarding a weight of V in the program logic graph G_{L}=(V_{L}, E_{L}), the weight of the logic bit refers to a number of all gates acting on the logic bit.

Chip coupling graph G_{c}=(V_{c}, E_{c}) is an undirected graph, which represents a chip architecture coupling graph adopted by a real quantum computer. V_{c} is a set of physical bits Qᵢ, i∈{0, 1, 2, . . . , m−1}, E_{c} is a set of edges eᵢ in the chip coupling graph G_{c}=(V_{c}, E_{c}), which is represented by a physical bit pair, that is, e={Qᵢ, Qᵢ}, indicating that a CNOT gate may act on the physical bit pair {Qᵢ, Qⱼ}.

CNOT error rate ϵ is a parameter obtained from a measurement fidelity of a CNOT gate of a quantum computer chip (measured by a special program and varying with time, temperature and other indicators). For example, if the fidelity of the CNOT gate between Q₁ and Q₂ is 96.80%, the CNOT gate has an error rate ϵ=1−0.968=0.032.

The edge e of G_{c}=(V_{c}, E_{c}) has a weight ωₑ:

$${ω}_{e} = \frac{1}{ln {ϵ}_{e}} \qquad ( 1 )$$

E_{c} is a set of edges of G_{c}=(V_{c}, E_{c}). ϵₑ represents the error rate of the CNOT gate on {Qᵢ, Qⱼ}. When ϵₑ→0, ωₑ→0. According to the above limit analysis, the smaller the error rate ϵₑ of the CNOT gate, the smaller the weight of the edge e in the chip coupling graph G_{c}=(V_{c}, E_{c}), and the smaller the length of the edge. On the contrary, the larger the error rate ϵₑ of the CNOT gate, the larger the weight of the edge e in the chip coupling graph G_{c}=(V_{c}, E_{c}), and the larger the length of the edge.

Regarding a chip coupling weight graph G_{ω}=(V_{ω}, E_{ω}), the chip coupling weight graph G_{ω}=(V_{ω}, E_{ω}) is obtained by updating the chip coupling graph G_{c}=(V_{c}, E_{c}) and adding a weight ωₑ to the length of edge.

Regarding a measurement error rate ϵ_{M}, the measurement error rate ϵ_{M(Q}_{ᵢ}₎ of Qᵢ is defined as follows:

$${ϵ}_{M ( {Q}_{i} )} = \{ {ϵ}_{{M}_{0} ( {Q}_{i} )} + {ϵ}_{{M}_{1} ( {Q}_{i} )} / {ϵ}_{{M}_{j} ( {Q}_{i} )} = 1 - {Fid}_{{M}_{j ( {Q}_{i} )}} , j = 0 , 1 \} \qquad ( 2 )$$

$$wherein {Fid}_{{M}_{j ( {Q}_{i} )}} ,$$

j=0,1 is the measurement fidelity for |0 [symbol] and |1 [symbol] . Similar to the error rate of the CNOT gate, the measurement error rate for |0 [symbol] and |1 [symbol] come from the measurement fidelity provided by the quantum computer chip. For example, if the measurement fidelity of Q₁ is (97.7%, 94.0%), then the measurement error rate of a measurement result |0 [symbol] of Q₁ is ϵ_{M}_{₀}_{(q}_{₁}₎=1−0.977=0.023, and the measurement error rate of a measurement result |1 [symbol] of Q₁ is ϵ_{M}_{₁}_{(q}_{₁}₎=1−0.940=0.06.

The measurement error rate of Q₁ is as follows:

ϵ_{M(Q1)}=ϵ_{M}_{₀}_{(Q}_{₁}₎+ϵ_{M}_{₀}_{(Q}_{₁}₎=0.023+0.06=0.083 (3)

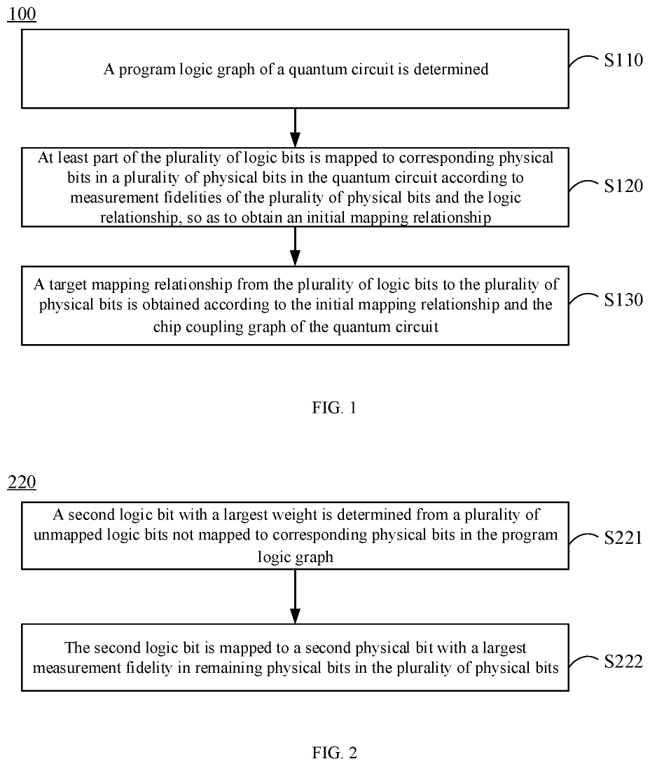

FIG. 1 shows a flowchart of a method of processing a quantum circuit according to embodiments of the present disclosure.

As shown in FIG. 1, a method 100 may include operation S110 to operation S130.

In operation S110, a program logic graph of a quantum circuit is determined.

In embodiments of the present disclosure, the program logic graph indicates a plurality of logic bits and a logic relationship between the plurality of logic bits.

In embodiments of the present disclosure, the logic relationship includes a connection relationship between the plurality of logic bits and a weight of each logic bit.

For example, the weight represents a number of logic gate associated with each logic bit. In an example, the logic gate may be the CNOT gate, the X gate or the H gate described above. In an example, a logic bit q₃ is associated with three CNOT gates, one X gate and two H gates, and the weight of this logic bit is 6. In another example, a logic bit q₁ is associated with one CNOT gate and two H gates, and the weight of this logic bit is 3.

In operation S120, at least part of the plurality of logic bits is mapped to corresponding physical bits in a plurality of physical bits in the quantum circuit according to measurement fidelities of the plurality of physical bits and the logic relationship, so as to obtain an initial mapping relationship.

In embodiments of the present disclosure, a first logic bit with a largest weight in the plurality of logic bits may be mapped to a first physical bit with a largest measurement fidelity in the plurality of physical bits.

For example, in a case that the logic bit q₃ has the largest weight and the physical bit Q₁ has the largest measurement fidelity, the logic bit q₃ may be determined as the first logic bit, and the physical bit Q₁ may be determined as the first physical bit. The logic bit q₃ is mapped to the physical bit Q₁, and a mapping q₃→Q₁ may be obtained.

In embodiments of the present disclosure, it is possible to determine I logic bits connected to the first logic bit in the program logic graph.

For example, J logic bits may be connected to the first logic bit in the program logic graph, where J is an integer, and J is greater than or equal to I. The I logic bits may be determined from the J logic bits connected to the first logic bit.

For example, I is an integer greater than or equal to 1.

For example, in the program logic graph, three logic bits including a logic bit q₀, a logic bit q₁ and a logic bit q₂ are connected to the first logic bit q₃.

In embodiments of the present disclosure, a number of Control-NOT gate between each of the I logic bits and the first logic bit may be determined.

For example, the number of CNOT gate between the logic bit q₀ and the first logic bit q₃ is 1, the number of CNOT gate between the logic bit q₁ and the first logic bit q₃ is 1, and the number of CNOT gate between the logic bit q₂ and the first logic bit q₃ is 1.

In embodiments of the present disclosure, according to the measurement fidelity of each of I physical bits coupled to the first physical bit in the chip coupling graph, the I logic bits are sequentially mapped to the I physical bits in descending order of the number of Control-NOT gate.

For example, the I logic bits are sequentially mapped to the I physical bits to obtain the initial mapping relationship.

For example, K physical bits are coupled to the first physical bit, where K is greater than or equal to I, and K is an integer. The I physical bits may be determined from the K physical bits connected to the first physical bit.

For example, a smaller value of the number of logic bit connected to the first logic bit and the number of physical bit coupled to the first physical bit may be determined as a value of I. For example, if the number of logic bits connected to the first logic bit is 3, and the number of physical bits coupled to the first physical bit is 2, the value of I may be 2.

For example, the I physical bits may be first I physical bits with a larger measurement fidelity in the K physical bits.

For example, taking I=2 as an example, two physical bits coupled to the first physical bit Q₁ are respectively a physical bit Q₀ and a physical bit Q₂, and the measurement fidelity of the physical bit Q₂ is greater than that of the physical bit Q₀. In an example, since the numbers of CNOT gates respectively acting on the logic bit q₀ to the logic bit q₂ are equal to each other, the mapping may be performed in sequence according to a sequence number. The logic bit q₀ may be mapped to the physical bit Q₂ coupled to the first physical bit and with a larger measurement fidelity. The logic bit q₁ may be mapped to the physical bit Q₀ coupled to the first physical bit Q₁. Then, a mapping relationship q₀→Q₂, q₁→Q₀, q₃→Q₁ may be obtained. Next, the logic bit q₂ may be randomly mapped to other physical bit in the chip coupling graph. For example, the logic bit q₂ may be mapped to a physical bit Q₄. Accordingly, a mapping relationship q₀→Q₂, q₁→Q₀, q₂→Q₄, q₃→Q₁ may be obtained, which may be determined as the initial mapping relationship.

In operation S130, a target mapping relationship from the plurality of logic bits to the plurality of physical bits is obtained according to the initial mapping relationship and the chip coupling graph of the quantum circuit.

For example, based on the above-mentioned example mapping relationship q₀→Q₂, q₁→Q₀, q₂→Q₄, q₃→Q1 and the chip coupling graph, a SWAP gate is inserted into the quantum circuit to update the initial mapping relationship, so that an updated mapping relationship may be executed by the quantum circuit. In an example, the updated mapping relationship may be q₀→Q₃, q₁→Q₀, q₂→Q₁, q₃→Q₂. The updated mapping relationship may be determined as the target mapping relationship. Those skilled in the art may understand that the SWAP gate may be inserted in any manner, as long as the updated mapping relationship may be executed by the quantum circuit.

According to embodiments of the present disclosure, by comprehensively considering a program logic information, a hardware topology constraint and an operation error information, and taking a high-quality mapping of qubit as a priority, mapping a logic qubit that uses more CNOTs to a physical bit with a large measurement fidelity of CNOT may improve a reliability and a success rate of a program operation, so that a resource utilization of a quantum program in a NISQ system may be improved, and an operability of a quantum program on a quantum device may be improved.

In some embodiments, the numbers of CNOT gates acting on the logic bit q₀, the logic bit q₁ and the logic bit q₂ decrease sequentially, unlike the above example in which the numbers of CNOT gates acting on the logic bit q₀ to the logic bit q₂ are equal to each other. In this example, the logic bit q₀ may be mapped to the physical bit Q₂ coupled to the first physical bit and with a larger measurement fidelity, and the logic bit q₁ may be mapped to the physical bit Q₀ coupled to the first physical bit. In addition, the logic bit q₂ may be randomly mapped to other physical bit in the chip coupling graph. For example, the logic bit q₂ may be mapped to a physical bit Q₈. Therefore, in this example, a mapping relationship q₀→Q₂, q₁→Q₀, q₂→Q₈, q₃→Q₁ may be obtained, which may be determined as the initial mapping relationship.

FIG. 2 shows a flowchart of a method of processing a quantum circuit according to other embodiments of the present disclosure.

As shown in FIG. 2, a method 220 may be implemented to map at least part of a plurality of logic bits to corresponding physical bits in a plurality of physical bits in a quantum circuit according to measurement fidelities of the plurality of physical bits and the logic relationship, which will be described below in detail with reference to operation S221 to operation S222. For example, the method 220 may be performed after the I logic bits are sequentially mapped to the I physical bits. In an example, the method 220 differs from the method 100 in that the method 200 is performed for the logic bit q₂ after the mapping relationship q₀→Q₂, q₁→Q₀, q₃→Q₁ is obtained.

In operation S221, a second logic bit with a largest weight is determined from a plurality of unmapped logic bits not mapped to corresponding physical bits in the program logic graph.

For example, as described above, the mapping relationship q₀→Q₂, q₁→Q₀, q₃→Q₁ has been obtained, but the logic bit q₂ in the program logic graph is not mapped to a physical bit. The logic bit q₂ may be determined as the second logic bit. In another example, the program logic graph further contains a logic bit q₄, and the weight of the logic bit q₂ is greater than that of the logic bit q₄. Therefore, the logic bit q₂ may be determined as the second logic bit.

In operation S222, the second logic bit is mapped to a second physical bit with a largest measurement fidelity in remaining physical bits in the plurality of physical bits.

For example, the chip coupling graph further contains a physical bit Q₃ to a physical bit Q₉. A physical bit Q₆ has a largest measurement fidelity, and thus may be determined as the second physical bit. Then, the logic bit q₂ may be mapped to the physical bit Q₆. Combined with the obtained mapping relationship q₀→Q₂, q₁→Q₀, q₃→Q₁, it is possible to obtain a mapping relationship q₀→Q₂, q₁→Q₀, q₂→Q₆, q₃→Q1.

In practical applications, data of logic bits and the number of physical bits are large. If all the logic bits are mapped according to the above-mentioned methods, a large amount of computing resources may be consumed, and a time cost may be high.

In some embodiments, mapping at least part of the plurality of logic bits to the corresponding physical bits of the plurality of physical bits according to the measurement fidelities of the plurality of physical bits of the quantum circuit and the logic relationship may include: mapping remaining logic bits in the program logic graph randomly to remaining physical bits in the plurality of physical bits, in response to a determination that a predetermined proportion of logic bits in the program logic graph has been mapped to the corresponding physical bits

In embodiments of the present disclosure, if the number of logic bits in the program logic graph is n, where n is an even number, then a number of the predetermined proportion of logic bits may be n/2.

In embodiments of the present disclosure, if the number of logic bits in the program logic graph is n, where n is an odd number and n is an integer greater than or equal to 3, then a number of the predetermined proportion of logic bits may be (n−1)/2.

For example, taking n=4 as an example, a difference from the above-described embodiments is that the logic bit q₀ may be mapped to the physical bit Q₂ firstly in a process of mapping the logic bit q₀ and the logic bit q₁ sequentially to the physical bit Q₀ and the physical bit Q₂ in descending order of the number of CNOT gate after the logic bit q₃ is mapped to the physical bit Q₁ according to the above-mentioned methods. When it is determined that two logic bits (the logic bit q₀ and the logic bit q₃) have been mapped to the corresponding physical bits, the logic bit q₁ to the logic bit q₂ may be randomly mapped to the remaining physical bits. Then, a mapping relationship q₀→Q₂, q₁→Q₇, q₂→Q₅, q₃→Q₁ may be obtained. In this way, the computing resources may be saved, and the time cost may be reduced.

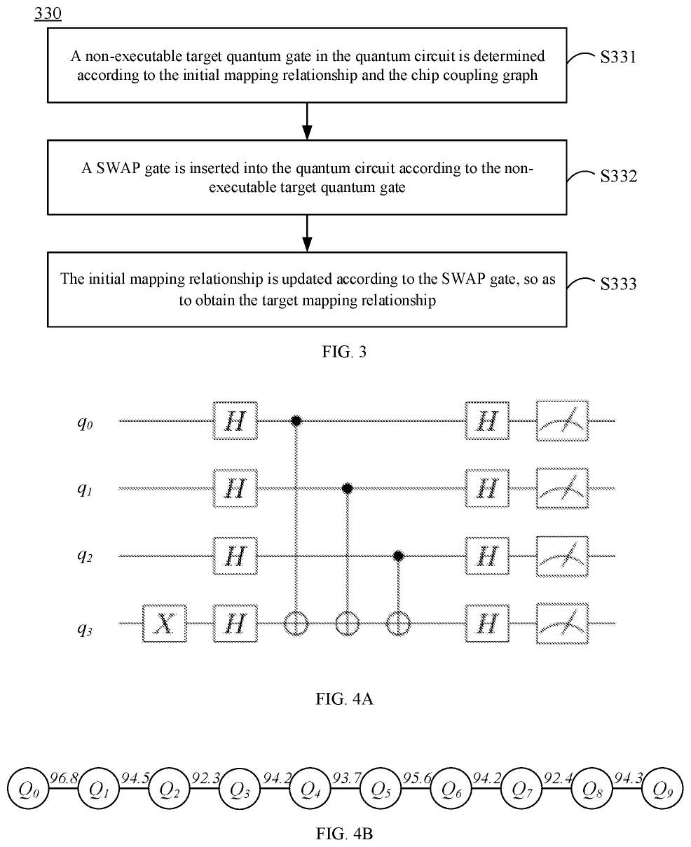

FIG. 3 shows a flowchart of a method of processing a quantum circuit according to other embodiments of the present disclosure.

As shown in FIG. 3, a method 330 may be implemented to obtain a target mapping relationship from a plurality of logic bits to a plurality of physical bits according to the initial mapping relationship and the chip coupling graph of the quantum circuit, which will be described below in detail with reference to operation S331 to operation S333.

In operation S331, a non-executable target quantum gate in the quantum circuit is determined according to the initial mapping relationship and the chip coupling graph.

For example, the target quantum gate may include a quantum gate that needs to act on a specific physical bit in the chip coupling graph, e.g., a quantum gate that needs to act on two adjacent physical bits, such as CNOT gate. A pair of bits that the target quantum gate acts on may be called a bit pair, and two physical bits may be called a physical bit pair. In a quantum circuit, if the target quantum gate does not act on the specific physical bit, the target quantum gate is non-executable. For example, if the CNOT gate acts on the logic bits q₃ and q₂, but the physical bits corresponding to q₃ and q₂ are not adjacent in the chip coupling graph, then the CNOT gate is non-executable.

For example, in such embodiments, the initial mapping relationship may be the above-mentioned initial mapping relationship q₀→Q₂, q₁→Q₀, q₂→Q₆, q₃→Q₁.

In an example, the quantum circuit contains a first CNOT gate and a second CNOT gate. The first CNOT gate acts on a logic bit pair (q₃,q₀), and the second CNOT gate acts on a logic bit pair (q₃,q₂). According to the initial mapping relationship, the logic bits q₃, gₒ, q₂ are respectively mapped to the physical bits Q₁, Q₂, Q₆, then the two physical bit pairs are respectively a first physical bit pair (Q₁,Q₂) and a second physical bit pair (Q₁,Q₆). If Q₁to Q₆ are connected in sequence according to the sequence number in the chip coupling graph, a non-adjacent physical bit pair (Q₁,Q₆) may be determined according to the chip coupling graph, and the corresponding logic bit pair is (q₃,q₂). Thus, the second CNOT gate acting on (q₃,q₂) is a non-executable quantum gate.

In operation S332, a SWAP gate is inserted into the quantum circuit according to the non-executable target quantum gate.

For example, the SWAP gate may be used to swap two qubits. By inserting the SWAP gate in the quantum circuit and updating the mapping relationship between the logic bits and the physical bits accordingly, the two physical bits corresponding to the logic bits that the target quantum gate acts on may be made close to each other, and an equivalence of the quantum circuit after conversion may be ensured, which may help to obtain a quantum circuit that may be implemented on a physical device.

In operation S333, the initial mapping relationship is updated according to the SWAP gate, so as to obtain the target mapping relationship.

For example, after the initial mapping relationship is updated according to the SWAP gate, the quantum circuit contains no non-executable target quantum gate, and the updated mapping relationship may be determined as the target mapping relationship.

Those skilled in the art may understand that the SWAP gate may be inserted in any manner so that the two physical bits corresponding to the logic bits that the target quantum gate acts on are made close to each other, and then the initial mapping relationship is updated.

According to embodiments of the present disclosure, the hardware topology constraint and the operation error information of the quantum circuit are further considered, and an availability of the quantum circuit may be improved.

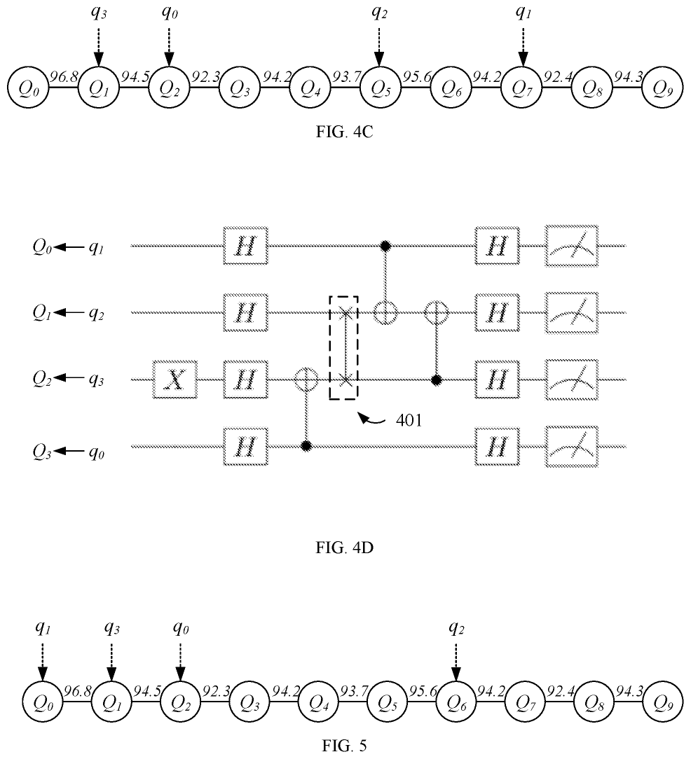

FIG. 4A shows a schematic diagram of a program logic graph according to embodiments of the present disclosure, FIG. 4B shows a schematic diagram of a chip coupling graph according to embodiments of the present disclosure, and FIG. 4C shows a schematic diagram of a method of processing a quantum circuit according to embodiments of the present disclosure. Next, an example method of mapping logic bits to physical bits according to embodiments of the present disclosure will be described with reference to FIG. 4A, FIG. 4B and FIG. 4C.

For ease of understanding, in an example shown in FIG. 4A, the program logic graph contains four logic bits, including a logic bit q₀, a logic bit q₁, a logic bit q₂ and a logic bit q₃. The logic bit connected to the logic bit q₀ by an edge is the logic bit q₃, so the degree of the logic bit q₀ is 1. The qubits connected to the logic bit q₃ by edges are respectively the logic bit q₀, the logic bit q₁, and the logic bit q₂, so the degree of the logic bit q₃ is 3.

As shown in FIG. 4A, six gates {X, H, CX(q₀, q₃), CX(q₁, q₃), CX(q₂, q₃), H} act on the logic bit q₃, so the weight of the logic bit q₃ is 6. Three gates act on each of the logic bit q₀, the logic bit q₁ and the logic bit q₂, so the weight of each of these three logic bits are 3.

In this example, since the logic bit q₃ has the largest weight, the logic bit q₃ may be determined as the first logic bit.

In the program logic graph, three logic bits, including the logic bit q₀, the logic bit q₁ and the logic bit q₂, are connected to the logic bit q₃. The number of CNOT gate between each of these three logic bits and the logic bit q₃ is 1.

In an example shown in FIG. 4B, the chip coupling graph contains ten physical bits. The physical bit Q₁ has a measurement fidelity of 96.8%, is the physical bit with a largest measurement fidelity in the ten physical bits and may be determined as the first physical bit. Therefore, according to embodiments of the present disclosure, the first logic bit q₃ with the largest weight in FIG. 4A may be mapped to the first physical bit Q₁.

In the example of the chip coupling graph shown in FIG. 4B, the physical bits coupled to the physical bit Q₁ include the physical bit Q₀ and the physical bit Q₂. The measurement fidelity of the physical bit Q₂ is greater than that of the physical bit Q₀, and the measurement fidelity of the physical bit Q₂ is 94.5%.

As shown in FIG. 4C, in this example, in a process of mapping at least part of the plurality of logic bits to the corresponding physical bits in the plurality of physical bits, the remaining logic bits in the program logic graph may be randomly mapped to the remaining physical bits in the plurality of physical bits when it is determined that a predetermined proportion of logic bits in the program logic graph has been mapped to the corresponding physical bits. A detailed description will be given below with reference to FIG. 4C.

In this example, there are four logic bits, and the predetermined proportion may be 50%. The first logic bit q₃ may be mapped to the first physical bit Q₁. The number of logic bits connected to the logic bit q₃ is 3, and the number of physical bits coupled to the physical bit Q₁ is 2. In such embodiments, the value of the above-mentioned I may be 2.

The number of CNOT gate between the logic bit q₃ and each of the logic bit q₀, the logic bit q₁ and the logic bit q₂ is 1. According to respective measurement fidelities of the two physical bits coupled to the first physical bit, the logic bits may be sequentially mapped to the two physical bits coupled to the first physical bit in an order of sequence number. For example, the logic bit q₀ may be mapped to the physical bit Q₂ firstly.

At this time, it may be determined that the predetermined proportion (50%) of logic bits in the program logic graph, for example, as shown in FIG. 4A, has been mapped to the corresponding physical bits. In this case, the remaining logic bits (the logic bit q₁ and the logic bit q₂) may be randomly mapped to the remaining physical bits (physical bits other than the physical bit Q₁ and the physical bit Q₂) to obtain the initial mapping relationship. For example, the logic bit q₁ may be mapped to the physical bit Q₇, and the logic bit q₂ may be mapped to the physical bit Q₅, and then a mapping relationship q₀→Q₂, q₁→Q₇, q₂→Qₛ, q₃→Q₁ may be obtained.

FIG. 4D shows a schematic diagram of a target mapping relationship according to embodiments of the present disclosure.

As shown in FIG. 4D, after the initial mapping relationship is obtained, a target mapping relationship q₀→Q₃, q₁→Q₀, q₂→Q₁, q₃→Q₂ may be obtained according to the initial mapping relationship and the chip coupling graph by using, for example, a SWAP heuristic search algorithm. In such embodiments, the initial mapping relationship may be, for example, the initial mapping relationship shown in FIG. 4C. Two “×” connected in a dashed box 401 in FIG. 4D represent a SWAP operation.

FIG. 5 shows a schematic diagram of a method of processing a quantum circuit according to other embodiments of the present disclosure.

The program logic graph adopted in such embodiments may be, for example, the program logic graph shown in FIG. 4A, and the chip coupling graph adopted may be, for example, the chip coupling graph shown in FIG. 4B.

As shown in FIG. 5, a difference from the schematic diagram shown in FIG. 4C is that in a process of mapping at least part of the plurality of logic bits to the corresponding physical bits in the plurality of physical bits in such embodiments, the mapping relationship between the logic bits and the physical bits may be established according to the number of CNOT gate between the plurality of logic bits and the first logic bit, and the weight of unmapped logic bit. A detailed description will be given below with reference to FIG. 5.

As shown in FIG. 5, the first logic bit q₃ may be mapped to the first physical bit Q₁. The number of logic bits connected to the logic bit q₃ is 3, and the number of physical bits coupled to the physical bit Q₁ is 2. In such embodiments, the value of the above-mentioned I may be 2.

The number of CNOT gate between the logic bit q₃ and each of the logic bit q₀, the logic bit q₁ and the logic bit q₂ is 1. According to respective measurement fidelities of the two physical bits coupled to the first physical bit, the logic bits may be sequentially mapped to the two physical bits coupled to the first physical bit in an order of sequence number. For example, the logic bit q₀ may be mapped to the physical bit Q₂, and then the logic bit q₁ may be mapped to the physical bit Q₀.

At this time, the unmapped logic bit not mapped to the corresponding physical bit in the program logic graph is the logic bit q₂, and the logic bit q₂ may be determined as the second logic bit. Seven physical bits in the chip coupling graph do not have a mapping relationship with logic bits, and these seven physical bits may be determined as the above-mentioned remaining physical bits. A physical bit with a largest measurement fidelity in the remaining physical bits is the physical bit Q₆, which may be determined as the second physical bit.

Next, the logic bit q₂ may be mapped to the physical bit Q₆. Then, an initial mapping relationship q₀→Q₂, q₁→Q₀, q₂→Q₆, q₃→Q₁ may be obtained.

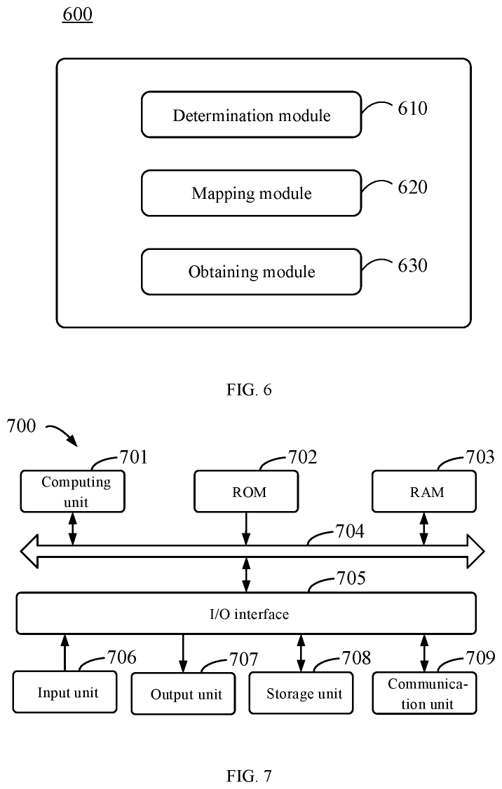

FIG. 6 shows a block diagram of an apparatus of processing a quantum circuit according to embodiments of the present disclosure.

As shown in FIG. 6, an apparatus 600 may include a determination module 610, a mapping module 620, and an obtaining module 630.

The determination module 610 may be used to determine a program logic graph of the quantum circuit, and the program logic graph indicates a plurality of logic bits and a logic relationship between the plurality of logic bits.

The mapping module 620 may be used to map at least part of the plurality of logic bits to corresponding physical bits in a plurality of physical bits in the quantum circuit according to measurement fidelities of the plurality of physical bits and the logic relationship, so as to obtain an initial mapping relationship.

The obtaining module 630 may be used to obtain a target mapping relationship from the plurality of logic bits to the plurality of physical bits according to the initial mapping relationship and a chip coupling graph of the quantum circuit.

In some embodiments, the logic relationship includes a connection relationship between the plurality of logic bits and a weight of each logic bit, and the weight represents a number of logic gate associated with each logic bit.

In some embodiments, the mapping module includes: a first mapping unit used to map a first logic bit with a largest weight in the plurality of logic bits to a first physical bit with a largest measurement fidelity in the plurality of physical bits.

In some embodiments, the mapping module includes: a first determination unit used to determine I logic bits connected to the first logic bit in the program logic graph, where I is an integer greater than or equal to 1; a second determination unit used to determine a number of Control-NOT gate between each of the I logic bits and the first logic bit; and a second mapping unit used to map, according to the measurement fidelity of each of I physical bits coupled to the first physical bit in the chip coupling graph, the I logic bits to the I physical bits sequentially in descending order of the number of Control-NOT gate.

In some embodiments, the mapping module further includes: a third determination unit used to determine a second logic bit with a largest weight from a plurality of unmapped logic bits not mapped to corresponding physical bits in the program logic graph; and a third mapping unit used to map the second logic bit to a second physical bit with a largest measurement fidelity in remaining physical bits in the plurality of physical bits.

In some embodiments, the mapping module includes: a fourth mapping unit used to map remaining logic bits in the program logic graph randomly to remaining physical bits in the plurality of physical bits, in response to a determination that a predetermined proportion of logic bits in the program logic graph has been mapped to the corresponding physical bits.

In some embodiments, the obtaining module includes: a fourth determination unit used to determine a non-executable target quantum gate in the quantum circuit according to the initial mapping relationship and the chip coupling graph; an insertion unit used to insert a SWAP gate into the quantum circuit according to the non-executable target quantum gate; and an update unit used to update the initial mapping relationship according to the SWAP gate, so as to obtain the target mapping relationship.

In the technical solutions of the present disclosure, a collection, a storage, a use, a processing, a transmission, a provision and a disclosure of user personal information involved comply with provisions of relevant laws and regulations, and do not violate public order and good custom.

According to embodiments of the present disclosure, the present disclosure further provides an electronic device, a readable storage medium, and a computer program product.

FIG. 7 shows a schematic block diagram of an exemplary electronic device 700 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the electronic device 700 includes a computing unit 701 which may perform various appropriate actions and processes according to a computer program stored in a read only memory (ROM) 702 or a computer program loaded from a storage unit 708 into a random access memory (RAM) 703. In the RAM 703, various programs and data necessary for an operation of the electronic device 700 may also be stored. The computing unit 701, the ROM 702 and the RAM 703 are connected to each other through a bus 704. An input/output (I/O) interface 705 is also connected to the bus 704.

A plurality of components in the electronic device 700 are connected to the I/O interface 705, including: an input unit 706, such as a keyboard, or a mouse; an output unit 707, such as displays or speakers of various types; a storage unit 708, such as a disk, or an optical disc; and a communication unit 709, such as a network card, a modem, or a wireless communication transceiver. The communication unit 709 allows the electronic device 700 to exchange information/data with other devices through a computer network such as Internet and/or various telecommunication networks.

The computing unit 701 may be various general-purpose and/or dedicated processing assemblies having processing and computing capabilities. Some examples of the computing unit 701 include, but are not limited to, a central processing unit (CPU), a graphics processing unit (GPU), various dedicated artificial intelligence (Al) computing chips, various computing units that run machine learning model algorithms, a digital signal processing processor (DSP), and any suitable processor, controller, microcontroller, etc. The computing unit 701 executes various methods and processes described above, such as the method of processing the quantum circuit. For example, in some embodiments, the method of processing the quantum circuit may be implemented as a computer software program which is tangibly embodied in a machine-readable medium, such as the storage unit 708. In some embodiments, the computer program may be partially or entirely loaded and/or installed in the electronic device 700 via the ROM 702 and/or the communication unit 709. The computer program, when loaded in the RAM 703 and executed by the computing unit 701, may execute one or more steps in the method of processing the quantum circuit. Alternatively, in other embodiments, the computing unit 701 may be used to perform the method of processing the quantum circuit by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, in sequence, or in a different order, as long as a desired result for the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of processing a quantum circuit, the method comprising:
determining a program logic graph of the quantum circuit, wherein the program logic graph indicates a plurality of logic bits and a logic relationship between the plurality of logic bits;
mapping at least part of the plurality of logic bits to corresponding physical bits in a plurality of physical bits in the quantum circuit according to measurement fidelities of the plurality of physical bits and the logic relationship, so as to obtain an initial mapping relationship; and
obtaining a target mapping relationship from the plurality of logic bits to the plurality of physical bits according to the initial mapping relationship and a chip coupling graph of the quantum circuit.

2. The method according to claim 1, wherein the logic relationship comprises a connection relationship between the plurality of logic bits and a weight of each logic bit, and the weight represents a number of logic gate associated with each logic bit.

3. The method according to claim 2, wherein the mapping at least part of the plurality of logic bits to corresponding physical bits in a plurality of physical bits in the quantum circuit according to measurement fidelities of the plurality of physical bits and the logic relationship comprises mapping a first logic bit with a largest weight in the plurality of logic bits to a first physical bit with a largest measurement fidelity in the plurality of physical bits.

4. The method according to claim 3, wherein the mapping at least part of the plurality of logic bits to corresponding physical bits in a plurality of physical bits in the quantum circuit according to measurement fidelities of the plurality of physical bits and the logic relationship comprises:
determining I logic bits connected to the first logic bit in the program logic graph, where I is an integer greater than or equal to 1;
determining a number of Control-NOT gate between each of the I logic bits and the first logic bit; and
mapping, according to the measurement fidelity of each of I physical bits coupled to the first physical bit in the chip coupling graph, the I logic bits to the I physical bits sequentially in descending order of the number of Control-NOT gate.

5. The method according to claim 4, wherein the mapping at least part of the plurality of logic bits to corresponding physical bits in a plurality of physical bits in the quantum circuit according to measurement fidelities of the plurality of physical bits and the logic relationship further comprises:
determining a second logic bit with a largest weight from a plurality of unmapped logic bits not mapped to corresponding physical bits in the program logic graph; and
mapping the second logic bit to a second physical bit with a largest measurement fidelity in remaining physical bits in the plurality of physical bits.

6. The method according to claim 4, wherein the mapping at least part of the plurality of logic bits to corresponding physical bits in a plurality of physical bits in the quantum circuit according to measurement fidelities of the plurality of physical bits and the logic relationship comprises mapping remaining logic bits in the program logic graph randomly to remaining physical bits in the plurality of physical bits, in response to a determination that a predetermined proportion of logic bits in the program logic graph has been mapped to the corresponding physical bits.

7. The method according to claim 1, wherein the obtaining a target mapping relationship from the plurality of logic bits to the plurality of physical bits according to the initial mapping relationship and a chip coupling graph of the quantum circuit comprises:
determining a non-executable target quantum gate in the quantum circuit according to the initial mapping relationship and the chip coupling graph;
inserting a SWAP gate into the quantum circuit according to the non-executable target quantum gate; and
updating the initial mapping relationship according to the SWAP gate, so as to obtain the target mapping relationship.

8. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
determine a program logic graph of a quantum circuit, wherein the program logic graph indicates a plurality of logic bits and a logic relationship between the plurality of logic bits;
map at least part of the plurality of logic bits to corresponding physical bits in a plurality of physical bits in the quantum circuit according to measurement fidelities of the plurality of physical bits and the logic relationship, so as to obtain an initial mapping relationship; and
obtain a target mapping relationship from the plurality of logic bits to the plurality of physical bits according to the initial mapping relationship and a chip coupling graph of the quantum circuit.

9. The electronic device according to claim 8, wherein the logic relationship comprises a connection relationship between the plurality of logic bits and a weight of each logic bit, and the weight represents a number of logic gate associated with each logic bit.

10. The electronic device according to claim 9, wherein the instructions, when executed by the processor, are further configured to cause the processor to map a first logic bit with a largest weight in the plurality of logic bits to a first physical bit with a largest measurement fidelity in the plurality of physical bits.

11. The electronic device according to claim 10, wherein the instructions, when executed by the processor, are further configured to cause the processor to:
determine I logic bits connected to the first logic bit in the program logic graph, where I is an integer greater than or equal to 1;
determine a number of Control-NOT gate between each of the I logic bits and the first logic bit; and
map, according to the measurement fidelity of each of I physical bits coupled to the first physical bit in the chip coupling graph, the I logic bits to the I physical bits sequentially in descending order of the number of Control-NOT gate.

12. The electronic device according to claim 11, wherein the instructions, when executed by the processor, are further configured to cause the processor to:
determine a second logic bit with a largest weight from a plurality of unmapped logic bits not mapped to corresponding physical bits in the program logic graph; and
map the second logic bit to a second physical bit with a largest measurement fidelity in remaining physical bits in the plurality of physical bits.

13. The electronic device according to claim 11, wherein the instructions, when executed by the processor, are further configured to cause the processor to map remaining logic bits in the program logic graph randomly to remaining physical bits in the plurality of physical bits, in response to a determination that a predetermined proportion of logic bits in the program logic graph has been mapped to the corresponding physical bits.

14. The electronic device according to claim 8, wherein the instructions, when executed by the processor, are further configured to cause the processor to:
determine a non-executable target quantum gate in the quantum circuit according to the initial mapping relationship and the chip coupling graph;
insert a SWAP gate into the quantum circuit according to the non-executable target quantum gate; and
update the initial mapping relationship according to the SWAP gate, so as to obtain the target mapping relationship.

15. A non-transitory computer-readable storage medium having computer instructions therein, the computer instructions configured to cause a computer system to at least:
determine a program logic graph of a quantum circuit, wherein the program logic graph indicates a plurality of logic bits and a logic relationship between the plurality of logic bits;
map at least part of the plurality of logic bits to corresponding physical bits in a plurality of physical bits in the quantum circuit according to measurement fidelities of the plurality of physical bits and the logic relationship, so as to obtain an initial mapping relationship; and
obtain a target mapping relationship from the plurality of logic bits to the plurality of physical bits according to the initial mapping relationship and a chip coupling graph of the quantum circuit.

16. The storage medium according to claim 1, wherein the logic relationship comprises a connection relationship between the plurality of logic bits and a weight of each logic bit, and the weight represents a number of logic gate associated with each logic bit.

17. The storage medium according to claim 16, wherein the computer instructions are further configured to cause the computer system to map a first logic bit with a largest weight in the plurality of logic bits to a first physical bit with a largest measurement fidelity in the plurality of physical bits.

18. The storage medium according to claim 17, wherein the computer instructions are further configured to cause the computer system to:
determine I logic bits connected to the first logic bit in the program logic graph, where I is an integer greater than or equal to 1;
determine a number of Control-NOT gate between each of the I logic bits and the first logic bit; and
map, according to the measurement fidelity of each of I physical bits coupled to the first physical bit in the chip coupling graph, the I logic bits to the I physical bits sequentially in descending order of the number of Control-NOT gate.

19. The storage medium according to claim 18, wherein the computer instructions are further configured to cause the computer system to:
determine a second logic bit with a largest weight from a plurality of unmapped logic bits not mapped to corresponding physical bits in the program logic graph; and
map the second logic bit to a second physical bit with a largest measurement fidelity in remaining physical bits in the plurality of physical bits.

20. The storage medium according to claim 18, wherein the computer instructions are further configured to cause the computer system to map remaining logic bits in the program logic graph randomly to remaining physical bits in the plurality of physical bits, in response to a determination that a predetermined proportion of logic bits in the program logic graph has been mapped to the corresponding physical bits.
